(19) United States
(12) Patent Application Publication
(10) Pub. No.: US 2008/0255272 A1
(43) Pub. Date: Oct. 16, 2008

(54) Hybrid-Powder Paint Composition Having a Low Burning Temperature For Semi-Glossy to Matt Coverings

(75) Inventors: Volker Weiss, Haltern am See (DE); Werner Grenda, Herne (DE)

Correspondence Address: OBLON, SPIVAK, MCCLELLAND MAIER & NEUSTADT, P.C., 1940 DUKE STREET, ALEXANDRIA, VA, 22314, US

(73) Assignee: EVONIK DEGUSSA GmbH, Essen (DE)

(21) Appl. No.: 12/066,325

(22) PCT Filed: Jun. 2, 2006
(86) PCT No.: PCT/EP06/62873

§ 371 Date: Mar. 10, 2008

(30) Foreign Application Priority Data
Sep. 9, 2005 (DE) 10 2005 042 822.3

(51) Int. Cl. C09D 163/00; C08K 5/20; C08K 5/16

(52) U.S. Cl. 523/455; 523/461

(57) ABSTRACT

Hybrid powder coating composition with low baking temperature for semiglossy to matt (flat) coatings.

The invention relates to hybrid powder coating compositions with a low baking temperature for semiglossy to matt (flat) coatings, to a process for preparing them, and to their use.

DE-A 23 24 696 describes a process for producing matt coatings by curing epoxy resins with salts of aromatic polycarboxylic acids, especially pyromellitic acid, and cyclic amidines. In particular the mono-salt described therein of pyromellitic acid and phenylimidazoline has become established worldwide as the most extensively used matt curing agent for both epoxy and hybrid systems.

DE-A 44 00 931 claims salts of pyromellitic acid and guanidines as curing agents for matt epoxy and hybrid coatings.

DE-A 44 03 225 describes salts of pyromellitic acid and tertiary amines which can be used for producing matt epoxy and hybrid coatings.

DE 29 22 377 A1 discloses a powder coating material, a hybrid system, composed of epoxy resins, acidic polyester, and an ammonium carboxylate catalyst, which can be baked at 180° C. rather than 200° C. (20 minutes in each case) and which in spite of catalyst leads to surfaces which flow out very well and exhibit no yellowing. All of the examples given lead to high-gloss coatings.

It was an object of the present invention to find a powder coating composition which likewise can be cured at temperatures well below 200° C. but leads to coatings having a semiglossy to matt appearance.

Surprisingly it has been found that the composition of the invention not only leads to a reduction in the baking temperature of the powder coating composition to approximately 160° C. but also, at the same time, produces the target semiglossy to matt coating surface.

The invention provides a powder coating composition substantially containing
A) at least 12% by weight of at least one carboxyl-containing polyester having an acid number of from 20 to 150 mg KOH/g, an average molecular weight (M_{w}) of from 1000 to 5000 g/mol, and a melting range of from 60 to 160° C.,
   and
B) at least 30% by weight of at least one epoxy resin which has a melting point of from 60 to 150° C. and an epoxide equivalent weight of from 400 to 3000 and contains on average more than one 1,2-epoxide group per molecule,
   and
C) from 1.5% to 12% by weight of at least one curing agent composed of the mono-salt of an aromatic polycarboxylic acid and a cyclic amidine,
   and
D) at least 0.2% to 1.5% by weight of at least one tetraalkylammonium compound as catalyst,
   and
E) 0 to 45% by weight of auxiliaries and additives.

All the percentages are based on the sum of all the ingredients of the powder coating composition.

The carboxyl-containing polyesters A) are polyester polycarboxylic acids prepared from polyols and polycarboxylic acids and/or derivatives thereof. The melting range of these acidic polyesters is situated in a range from 60 to 160° C., preferably from 80 to 120° C.; their acid number varies from 20 to 150 mg KOH/g, preferably from 30 to 60 mg KOH/g. The OH numbers ought to be below 10 mg KOH/g. The average molecular weight (M_{w}) is from 1000 to 5000 g/mol. The polyesters are contained in the powder coating composition of the invention in amounts of from 12% to 30% by weight, preferably from 15% to 25% by weight.

The polyesters A) to be employed are prepared using polycarboxylic acids, such as oxalic, adipic, 2,2,4(2,4,4)-trimethyladipic, azelaic, sebacic, decanedicarboxylic, dodecane-dicarboxylic, fumaric, phthalic, isophthalic, terephthalic, trimellitic and/or pyromellitic acid, for example. Examples of polyols used for preparing the acidic polyester A) include the following: ethylene glycol, 1,2- and 1,3-propanediol, 1,2-, 1,3-, 1,4- and 2,3-butanediol, 1,5-pentanediol, 3-methyl-1,5-pentanediol, neopentyl glycol, 1,12-dodecanediol, 2,2,4(2,4,4)-trimethyl-1,6-hexanediol, trimethylolpropane, glycerol, pentaerythritol, 1,4-bis-hydroxymethylcyclohexane, cyclohexane-1,4-diol, diethylene glycol, triethylene glycol, and dipropylene glycol. It will be appreciated that hydroxyl-containing acidic polyesters, prepared by known methods from polycarboxylic acids and polyols, can also be reacted with polycarboxylic acids and/or polycarboxylic anhyrides to form the polyester polycarboxylic acids. Preferred monomers are adipic, succinic, isophthalic, terephthalic, trimellitic, 1,10-decanedioic, and 1,12-dodecanedioic acid.

The epoxy resins B) used are solid, resinlike substances which melt in the range from 60 to 150° C., preferably from 70 to 110° C., and contain on average more than one 1,2-epoxide group per molecule. Suitable compounds are in principle all those which contain more than one 1,2-epoxide group per molecule. Examples are polyepoxides such as polyglycidyl ethers of aromatic or aliphatic compounds which contain two or more hydrogen atoms. These include resorcinol, hydroquinone, pyrocatechol, bisphenol A, bisphenol F, glycerol, pentaerythritol, mannitol, sorbitol, and trimethylolpropane. Preference, however, is given to commercially customary EP resins as are obtained by reacting bisphenol A or bisphenol F with epichlorohydrin. Very particular preference is given to using EP resins based on the reaction between bisphenol A and epichlorohydrin, with an EP equivalent weight of from 400 to 3000, preferably from 800 to 1000, in amounts of from 30% to 40% by weight.

In the powder coating compositions of the invention the curing agent C), composed of the mono-salt of an aromatic polycarboxylic acid and a cyclic amidine, is used in amounts of from 1.5% to 12% by weight, based on the sum of all the ingredients. A particularly suitable mono-salt is that of pyromellitic acid and phenylimidazoline, which is sold, for example, under the product name VESTAGON B 68 by Degussa, Germany. A customary preparation involves admixing an aqueous pyromellitic acid solution at approximately 70° C. with the corresponding amount of phenylimidazoline (1 mol of imidazoline per mole of acid), homogenizing the reaction mixture at from 70 to 80° C. for an hour, and then cooling it to room temperature. The mono-salt, which is of low solubility, precipitates and is isolated by filtration, dried, and then finely ground. The high-melting mono-salt thus prepared can then be used in this form as a curing agent in the powder coating composition of the invention.

Tetraalkylammonium compounds, halides and carboxylates, preferably in amounts of from 0.2% to 1.5% by weight, are employed as catalyst D). Particularly suitable tetraalkylammonium salts are those based on the following carboxylic acids: acetic, propionic, benzoic, adipic, terephthalic, and isophthalic acid. Particular suitability is possessed by tetraethylammonium benzoate, tetrabutylammonium benzoate, benzyltrimethylammonium chloride, and tetrabutylammonium bromide. The commercially customary products (e.g. Merck, Aldrich, Fluka) can be added in their powder form as supplied, directly or as a pre-prepared blend with the curing agent C), to the powder coating premix.

Customary auxiliaries and additives are flow control agents, pigments, and fillers, and the amount in which they are added can be varied in the range from 0 to 45% by weight.

The invention also provides a process for preparing a powder coating composition substantially containing
A) at least 12% by weight of at least one carboxyl-containing polyester having an acid number of from 20 to 150 mg KOH/g, an average molecular weight M_{w} of from 1000 to 5000 g/mol, and a melting range of from 60 to 160° C.,
   and
B) at least 30% by weight of at least one epoxy resin which has a melting point of from 60 to 150° C. and an epoxide equivalent weight of from 400 to 3000 and contains on average more than one 1,2-epoxide group per molecule,
   and
C) from 1.5% to 12% by weight of at least one curing agent composed of the mono-salt of an aromatic polycarboxylic acid and a cyclic amidine,
   and
D) at least 0.2% to 1.5% by weight of at least one tetraalkylammonium compound as catalyst,
   and
E) 0 to 45% by weight of auxiliaries and additives
   by mixing and subsequently homogenizing components A) to E).

The ready-to-use powder coating materials are prepared by mixing the COOH-functionalized polyester, the epoxy resin, the curing agent, the catalyst, flow control agent(s), pigments, and fillers with one another at room temperature and subsequently homogenizing the mixture on an extruder or compounder at temperatures from 100 to 140° C. After it has cooled, the extrudate is fractionated, ground, and then sieved to a particle size <100 μm. The ratio of polyester to resin is chosen such that there are 0.3 to 0.8, preferably 0.5 to 0.6, COOH groups available per epoxy group; to consume the remaining epoxy groups of the resin, a corresponding amount of curing agent is added. Since the curing agent also exerts a catalytic effect on the various reactions which take place in the course of baking, a precise stoichiometric calculation of the amount of curing agent required for a particular degree-of-gloss setting is not possible, and it must therefore be determined empirically. In order to obtain very low degrees of gloss, the fraction of polyester chosen must be low and the fraction of curing agent chosen must be relatively high.

The powder coating compositions of the invention are suitable for producing coatings having surfaces ranging from semiglossy to—preferably—matt. The amounts of the individual powder coating binder components can be varied widely.

Application of the powder coating composition of the invention to suitable substrates may take place by the known methods, such as by electrostatic powder spraying or by fluid-bed sintering, with or without electrostatic assistance. Following the application of the powder coating material by one of the stated methods, the coated substrates are cured by heating at temperatures from 150 to 180° C., preferably 150 to 170° C., more preferably 155 to 165° C., 157 to 165° C., 158 to 162° C., and, with very particular preference, at 160° C. over a period of from 30 to 8 minutes. The coating films produced in this way are distinguished by very good leveling, good to very good mechanical properties, and a semiglossy to—preferably—matt surface; the degree of gloss can be set as desired within a wide range. The degree-of-gloss measurement takes place in accordance with DIN EN ISO 2813 by means of a reflectometer, whose use for determining gloss on planar paint and coating surfaces is described in DIN 67 530. The instrument can be operated at three different incident angles (20°, 60°, and 85°), with 20° being used preferably for very matt surfaces and 85° for highly glossy surfaces; the 60° angle is suitable particularly for measuring degrees of gloss on moderately glossy surfaces, but is also suitable for universal determination of degree of gloss.

The invention also provides for the use of a powder coating composition substantially containing
A) at least 12% by weight of at least one carboxyl-containing polyester having an acid number of from 20 to 150 mg KOH/g, an average molecular weight M_{w} of from 1000 to 5000 g/mol, and a melting range of from 60 to 160° C.,
   and
B) at least 30% by weight of at least one epoxy resin which has a melting point of from 60 to 150° C. and an epoxide equivalent weight of from 400 to 3000 and contains on average more than one 1,2-epoxide group per molecule,
   and
C) from 1.5% to 12% by weight of at least one curing agent composed of the mono-salt of an aromatic polycarboxylic acid and a cyclic amidine,
   and
D) at least 0.2% to 1.5% by weight of at least one tetraalkylammonium compound as catalyst,
   and
E) 0 to 45% by weight of auxiliaries and additives for producing coatings having a semiglossy to matt surface.

The invention further provides coatings having a semiglossy to matt surface, containing a powder coating composition substantially containing
A) at least 12% by weight of at least one carboxyl-containing polyester having an acid number of from 20 to 150 mg KOH/g, an average molecular weight M_{w} of from 1000 to 5000 g/mol, and a melting range of from 60 to 160° C.,
   and
B) at least 30% by weight of at least one epoxy resin which has a melting point of from 60 to 150° C. and an epoxide equivalent weight of from 400 to 3000 and contains on average more than one 1,2-epoxide group per molecule,
   and
C) from 1.5% to 12% by weight of at least one curing agent composed of the mono-salt of an aromatic polycarboxylic acid and a cyclic amidine,
   and
D) at least 0.2% to 1.5% by weight of at least one tetraalkylammonium compound as catalyst,
   and
E) 0 to 45% by weight of auxiliaries and additives,
   and also a process for producing coatings having a semiglossy to matt surface, produced at a curing temperature of from 150 to 180° C., preferably from 155 to 165° C., more preferably from 158 to 162° C., and very preferably at 160° C., from a powder coating composition substantially containing
A) at least 12% by weight of at least one carboxyl-containing polyester having an acid number of from 20 to 150 mg KOH/g, an average molecular weight (M_{w}) of from 1000 to 5000 g/mol, and a melting range of from 60 to 160° C.,
   and
B) at least 30% by weight of at least one epoxy resin which has a melting point of from 60 to 150° C. and an epoxide equivalent weight of from 400 to 3000 and contains on average more than one 1,2-epoxide group per molecule,
   and
C) from 1.5% to 12% by weight of at least one curing agent composed of the mono-salt of an aromatic polycarboxylic acid and a cyclic amidine,
   and
D) at least 0.2% to 1.5% by weight of at least one tetraalkylammonium compound as catalyst,
   and
E) 0 to 45% by weight of auxiliaries and additives.

### EXAMPLES

### 1. Preparation of the Powder Coating Composition

The powder coating compositions of the invention were prepared by intimately mixing the ingredients—curing agent, epoxy resin, polyester, catalyst, and flow control agent—with the white pigment (TiO₂) in an edge runner mill and subsequently homogenizing the mixture in an extruder at from 90 to 110° C. After the extrudate had cooled it was fractionated and then ground in a pinned-disk mill to a particle size <100 μm. The powder prepared as described above was applied using an electrostatic powder-spraying unit at 60 kV to steel panels which had been degreased and, if desired, pretreated, followed by baking in a laboratory forced-air drying cabinet.

The abbreviations in the tables which follow have the following meanings:

| | | |
|---|---|---|
| GG 60° angle = | Gardner gloss | (DIN EN ISO 2813) |
| EC = | Erichsen cupping in mm | (DIN 53 156) |
| BI dir. = | Ball impact, direct, in inch*lb | (ASTM D 2794-93) |
| BI rev = | Ball impact, reverse in inch*lb | (ASTM D 2794-93) |

### 2: Hybrid Powder Coatings (Catalyst: Tetraethylammonium Benzoate; Epoxy Resin to Polyester Ratio=67:33)

### Formulating Examples:

| | Formula | | | | |
|---|---|---|---|---|---|
| | 1 | 2 | 3 | 4 | 5 |
| B 68 | 5.0 | 5.0 | 5.0 | 5.0 | 5.0 |
| EPIKOTE 1055 | 36.2 | 36.0 | 35.9 | 35.8 | 35.7 |
| CRYLCOAT 316 | 17.8 | 17.8 | 17.8 | 17.8 | 17.8 |
| KRONOS 2220 | 40.0 | 40.0 | 40.0 | 40.0 | 40.0 |
| RESIFLOW PV 88 | 1.0 | 1.0 | 1.0 | 1.0 | 1.0 |
| TEAB | 0.0 | 0.2 | 0.3 | 0.4 | 0.5 |

Amounts in % by mass
VESTAGON B 68: curing agent, Degussa AG
EPIKOTE 1055: epoxy resin, Resolution
CRYLCOAT 316: polyester, Cytec
KRONOS 2220: titanium dioxide, Kronos
RESIFLOW PV 88: flow control agent, Worlee
TEAB: tetraethylammonium benzoate, Fluka

### Coatings Testing Results

1) Curing conditions: 15 min/200° C.

| | Formula | | | | |
|---|---|---|---|---|---|
| | 1 | 2 | 3 | 4 | 5 |
| EC (mm) | 9.0 | 8.5 | 9.5 | 9.0 | 8.5 |
| BI dir. | >80 | >80 | >80 | >80 | >80 |
| BI rev. | >80 | >80 | 60 | 80 | 40 |
| GG 60° | 11 | 10 | 9 | 10 | 11 |

2) Curing conditions: 20 min/180° C.

| | Formula | | | | |
|---|---|---|---|---|---|
| | 1 | 2 | 3 | 4 | 5 |
| EC (mm) | 10.0 | 8.5 | 9.0 | 9.0 | 8.5 |
| BI dir. | >80 | >80 | 80 | >80 | 60 |
| BI rev. | >80 | >80 | 40 | 80 | 30 |
| GG 60° | 14 | 9 | 9 | 10 | 10 |

3) Curing conditions: 30 min/160° C.

| | Formula | | | | |
|---|---|---|---|---|---|
| | 1 | 2 | 3 | 4 | 5 |
| EC (mm) | 7.0 | 7.5 | 8.5 | 8.0 | 7.5 |
| BI dir. | 60 | >80 | 60 | 80 | 60 |
| BI rev. | 30 | 70 | 40 | 50 | 20 |
| GG 60° | 24 | 11 | 10 | 9 | 11 |

### 3: Hybrid Powder Coatings (Base: Tetrabutylammonium Bromide; Epoxy Resin to Polyester Ratio=67:33)

### Formulating Examples:

| | Formula | | |
|---|---|---|---|
| | 1 | 6 | 7 |
| B 68 | 5.0 | 5.0 | 5.0 |
| EPIKOTE 1055 | 36.2 | 35.9 | 35.7 |
| CRYLCOAT 316 | 17.8 | 17.8 | 17.8 |
| KRONOS 2220 | 40.0 | 40.0 | 40.0 |
| RESIFLOW PV 88 | 1.0 | 1.0 | 1.0 |
| TEABr | 0.0 | 0.3 | 0.5 |

VESTAGON B 68: curing agent, Degussa AG
EPIKOTE 1055: epoxy resin, Resolution
CRYLCOAT 316: COOH polyester, Cytec
KRONOS 2220: titanium dioxide, Kronos
RESIFLOW PV 88: flow control agent, Worlee
TEABr: tetraethylammonium bromide, Aldrich

### Coatings Testing Results:

1) Curing conditions: 15 min/200° C.

| | Formula | | |
|---|---|---|---|
| | 1 | 6 | 7 |
| EC (mm) | 9.0 | 9.0 | 9.5 |
| BI dir. | >80 | 80 | >80 |
| BI rev. | 80 | 30 | 60 |
| GG 60° | 11 | 12 | 11 |

2) Curing conditions: 20 min/180° C.

| | Formula | | |
|---|---|---|---|
| | 1 | 6 | 7 |
| EC (mm) | 10.0 | 8.5 | 9.0 |
| BI dir. | >80 | 70 | 80 |
| BI rev. | 80 | 20 | 30 |
| GG 60° | 16 | 11 | 12 |

3) Curing conditions: 30 min/160° C.

| | Formula | | |
|---|---|---|---|
| | 1 | 6 | 7 |
| EC (mm) | 7.0 | 7.5 | 8.0 |
| BI dir. | 60 | 60 | 70 |
| BI rev. | 30 | <10 | 20 |
| GG 60° | 24 | 12 | 12 |

### 4: Hybrid Powder Coatings (Basis: Tetraethylammonium Benzoate; Epoxy Resin to Polyester Mass Ratio=73:27)

### Formulating Examples:

| | Formula | | |
|---|---|---|---|
| | 8 | 9 | 10 |
| B 68 | 5.0 | 5.0 | 5.0 |
| EPIKOTE 1055 | 39.4 | 39.2 | 39.1 |
| CRYLCOAT 316 | 14.6 | 14.6 | 14.6 |
| KRONOS 2220 | 40.0 | 40.0 | 40.0 |
| RESIFLOW PV 88 | 1.0 | 1.0 | 1.0 |
| TEAB | 0.0 | 0.2 | 0.3 |

VESTAGON B 68: curing agent, Degussa AG
EPIKOTE 1055: epoxy resin, Resolution
KRONOS 2220: titanium dioxide, Kronos
RESIFLOW PV 88: flow control agent, Worlee
TEAB: tetraethylammonium benzoate, Fluka

### Coatings Testing Results:

1) Curing conditions: 15 min/200° C.

| | Formula | | |
|---|---|---|---|
| | 8 | 9 | 10 |
| EC (mm) | 8.0 | 8.5 | 8.5 |
| BI dir. | >80 | >80 | >80 |
| BI rev. | 20 | 40 | 30 |
| GG 60° | 9 | 7 | 8 |

2) Curing conditions: 20 min/180° C.

| | Formula | | |
|---|---|---|---|
| | 8 | 9 | 10 |
| EC (mm) | 9.0 | 8.5 | 9.0 |
| BI dir. | >80 | >80 | 80 |
| BI rev. | 60 | 80 | 40 |
| GG 60° | 14 | 9 | 10 |

3) Curing conditions: 30 min/160° C.

| | Formula | | |
|---|---|---|---|
| | 8 | 9 | 10 |
| EC (mm) | 2.5 | 7.5 | 8.5 |
| BI dir. | 40 | 80 | 70 |
| BI rev. | <10 | 40 | 30 |
| GG 60° | 16 | 9 | 9 |

1: A powder coating composition substantially containing
A) at least 12% by weight of at least one carboxyl-containing polyester having an acid number of from 20 to 150 mg KOH/g, an average molecular weight M_{w} of from 1000 to 5000 g/mol, and a melting range of from 60 to 160° C.,
and
at least 30% by weight of at least one epoxy resin which has a melting point of from 60 to 150° C. and an epoxide equivalent weight of from 400 to 3000 and contains on average more than one 1,2-epoxide group per molecule,
and
C) from 1.5% to 12% by weight of at least one curing agent composed of the mono-salt of an aromatic polycarboxylic acid and a cyclic amidine,
and
D) at least 0.2% to 1.5% by weight of at least one tetraalkylammonium compound as catalyst,
and
E) 0 to 45% by weight of auxiliaries and additives.

2: A powder coating composition as claimed in claim 1, containing carboxyl-containing polyesters A) having an acid number of from 30 to 60 mg KOH/g.

3: A powder coating composition as claimed in claim 1, containing carboxyl-containing polyesters A) having a melting range of from 80 to 120° C.

4: A powder coating composition as claimed in claim 1, comprising carboxyl-containing polyesters A) having an OH number of less than 10 mg KOH/g.

5: A powder coating composition as claimed in claim 1, containing carboxyl-containing polyesters A) based on adipic, 2,2,4(2,4,4)-trimethyladipic, azelaic, succinic, sebacic, decanedicarboxylic, dodecanedicarboxylic, fumaric, phthalic, isophthalic, terephthalic, trimellitic and/or pyromellitic acid.

6: A powder coating composition as claimed in claim 1, containing carboxyl-containing polyesters A) based on ethylene glycol, 1,2- and 1,3-propanediol, 1,2-, 1,3-, 1,4- and 2,3-butanediol, 1,5-pentanediol, 3-methyl-1,5-pentanediol, neopentyl glycol, 1,12-dodecanediol, 2,2,4(2,4,4)trimethyl-1,6-hexanediol, trimethylolpropane, glycerol, pentaerythritol, 1,4-bishydroxymethylcyclohexane, cyclohexane-1,4-diol, diethylene glycol, triethylene glycol and/or dipropylene glycol.

7: A powder coating composition as claimed in claim 1, containing carboxyl-containing polyesters A) based on adipic, succinic, isophthalic, terephthalic and/or trimellitic acid and ethylene glycol, 1,2- and 1,3-propanediol, 1,2-, 1,3-, 1,4- and 2,3-butanediol, 1,5-pentanediol, 3-methyl-1,5-pentanediol, neopentyl glycol, 1,12-dodecanediol, trimethylolpropane, cyclohexane-1,4-diol and/or diethylene glycol.

8: A powder coating composition as claimed in claim 1, containing epoxy resins B) having a melting point of from 70 to 110° C.

9: A powder coating composition as claimed in claim 1, containing epoxy resins B) based on resorcinol, hydroquinone, pyrocatechol, bisphenol A, bisphenol F, glycerol, pentaerythritol, mannitol, sorbitol, and trimethylolpropane.

10: A powder coating composition as claimed in claim 9, containing epoxy resins B) as are obtained by reacting bisphenol A or bisphenol F with epichlorohydrin.

11: A powder coating composition as claimed in claim 9, containing epoxy resins B) having an EP equivalent weight of from 800 to 1000.

12: A powder coating composition as claimed in claim 1, wherein the curing agent C) is based on the aromatic acid pyromellitic acid.

13: A powder coating composition as claimed in claim 1, wherein the curing agent C) is based on the base phenylimidazoline.

14: A powder coating composition as claimed in claim 1, wherein the curing agent C) is composed of the mono-salt of pyromellitic acid and phenylimidazoline.

15: A powder coating composition as claimed in claim 1, containing carboxylates and/or halides as catalyst D).

16: A powder coating composition as claimed in claim 15, containing carboxylates of the acids selected from acetic, propionic, benzoic, adipic, terephthalic and/or isophthalic acid.

17: A powder coating composition as claimed in claim 15, containing tetraethylammonium benzoate, tetrabutylammonium benzoate, benzyltrimethylammonium chloride and tetrabutylammonium bromide, alone or in mixtures, as catalyst D).

18: A process for preparing a powder coating composition substantially containing
A) at least 12% by weight of at least one carboxyl-containing polyester having an acid number of from 20 to 150 mg KOH/g, an average molecular weight M_{w} of from 1000 to 5000 g/mol, and a melting range of from 60 to 160° C.,
and
B) at least 30% by weight of at least one epoxy resin which has a melting point of from 60 to 150° C. and an epoxide equivalent weight of from 400 to 3000 and contains on average more than one 1,2-epoxide group per molecule,
and
C) from 1.5% to 12% by weight of at least one curing agent composed of the mono-salt of an aromatic polycarboxylic acid and a cyclic amidine,
and
D) at least 0.2% to 1.5% by weight of at least one tetraalkylammonium compound as catalyst,
and
E) 0 to 45% by weight of auxiliaries and additives
by mixing and subsequently homogenizing.

19: The method of using a powder coating composition substantially containing
A) at least 12% by weight of at least one carboxyl-containing polyester having an acid number of from 20 to 150 mg KOH/g, an average molecular weight M_{w} of from 1000 to 5000 g/mol, and a melting range of from 60 to 160° C.,
and
B) at least 30% by weight of at least one epoxy resin which has a melting point of from 60 to 150° C. and an epoxide equivalent weight of from 400 to 3000 and contains on average more than one 1,2-epoxide group per molecule,
and
C) from 1.5% to 12% by weight of at least one curing agent composed of the mono-salt of an aromatic polycarboxylic acid and a cyclic amidine, and
D) at least 0.2% to 1.5% by weight of at least one tetraalkylammonium compound as catalyst,
and
E) 0 to 45% by weight of auxiliaries and additives
for producing a coating having a semiglossy to matt surface.

20: A coating having a semiglossy to matt surface, containing a powder coating composition substantially containing A) at least 12% by weight of at least one carboxyl-containing polyester having an acid number of from 20 to 150 mg KOH/g, an average molecular weight M_{w} of from 1000 to 5000 g/mol, and a melting range of from 60 to 160° C.,
and
B) at least 30% by weight of at least one epoxy resin which has a melting point of from 60 to 150° C. and an epoxide equivalent weight of from 400 to 3000 and contains on average more than one 1,2-epoxide group per molecule,
and
C) from 1.5% to 12% by weight of at least one curing agent composed of the mono-salt of an aromatic polycarboxylic acid and a cyclic amidine,
and
D) at least 0.2% to 1.5% by weight of at least one tetraalkylammonium compound as catalyst,
and
E) 0 to 45% by weight of auxiliaries and additives.

21: A process for producing a coating having a semiglossy to matt surface, produced at a curing temperature of from 150 to 180° C., preferably from 155 to 165° C., more preferably from 158 to 162° C., and very preferably at 160° C., from a powder coating composition substantially containing
A) at least 12% by weight of at least one carboxyl-containing polyester having an acid number of from 20 to 150 mg KOH/g, an average molecular weight M_{w} of from 1000 to 5000 g/mol, and a melting range of from 60 to 160° C.,
and
B) at least 30% by weight of at least one epoxy resin which has a melting point of from 60 to 150° C. and an epoxide equivalent weight of from 400 to 3000 and contains on average more than one 1,2-epoxide group per molecule,
and
C) from 1.5% to 12% by weight of at least one curing agent composed of the mono-salt of an aromatic polycarboxylic acid and a cyclic amidine, and
D) at least 0.2% to 1.5% by weight of at least one tetraalkylammonium compound as catalyst,
and
E) 0 to 45% by weight of auxiliaries and additives
